(19) United States
(12) Patent Application Publication
(10) Pub. No.: US 2026/0196374 A1
(43) Pub. Date: Jul. 9, 2026

(54) HIGH-EFFICIENCY QUANTUM-ENHANCED MICROCRYSTALLINE CONVERTER FOR NUCLEAR VOLTAIC POWER SYSTEMS

(71) Applicant: NUBATT PTE. LTD., Singapore (SG)

(72) Inventor: Nima Golsharifi, London (GB)

(21) Appl. No.: 19/558,459

(22) Filed: Mar. 6, 2026

(30) Foreign Application Priority Data
Mar. 11, 2025 (SG) 10202500617Q

(51) Int. Cl. G21H 1/06; H02N 11/00

(52) U.S. Cl. CPC G21H 1/06; H02N 11/002

(57) ABSTRACT

A high-efficiency solid-state nuclear voltaic converter employs microcrystalline wide bandgap semiconductor materials including diamond, silicon carbide (SiC), gallium nitride (GaN), gallium oxide (Ga₂O₃), boron nitride (BN), and aluminum nitride (AlN) to convert ionizing radiation from radioisotopes into electrical power. The microcrystalline grains, having controlled dimensions of approximately 1 to 100 nanometers, exploit quantum mechanical phenomena including quantum confinement, quantum-confined Stark effect (QCSE), Lamb shift, Casimir effect, and Purcell effect to optimize charge generation, separation, and collection. The converter is adaptable to layered planar configurations with alternating radioisotope and semiconductor layers, and spherical configurations with concentric semiconductor shells interspersed with radioisotope material. The spherical geometry forms a resonant cavity enhancing the Purcell effect. The invention provides enhanced energy conversion efficiency, robust radiation tolerance, and design flexibility for applications including space exploration, medical devices, and remote sensors.

### CROSS-REFERENCE TO RELATED APPLICATIONS

This application claims priority to and is related to Singapore Patent Application No. 10202500617Q, filed on Mar. 11, 2025, with the Intellectual Property Office of Singapore (IPOS), the entire disclosure of which is incorporated herein by reference.

### FIELD OF THE INVENTION

The present invention relates generally to nuclear voltaic power sources and, more particularly, to a high-efficiency solid-state energy converter that employs microcrystalline wide bandgap semiconductor materials engineered to exploit quantum mechanical phenomena for converting ionizing radiation energy from radioisotopes directly into electrical power. The invention further relates to nuclear battery devices incorporating such converters in both layered planar and spherical geometries.

### BACKGROUND OF THE INVENTION

Nuclear voltaic technology, first established in 1913, encompasses devices that generate electrical charge through the inelastic scattering of high-energy particles emitted from radioisotopes into semiconductor materials. The radioisotopes emit alpha particles, beta particles, gamma rays, or combinations thereof during radioactive decay, and these energetic particles interact with the semiconductor lattice to create electron-hole pairs. By establishing appropriate built-in electric fields through p-n junctions or Schottky barriers, the generated charge carriers can be separated and collected as useful electrical current.

Traditional nuclear voltaic devices, commonly referred to as betavoltaic or alphavoltaic batteries depending on the type of radiation employed, have historically utilized narrow bandgap semiconductors such as silicon (Si, bandgap 1.12 eV) and gallium arsenide (GaAs, bandgap 1.42 eV). These materials suffer from fundamental limitations including: (a) low open-circuit voltage due to the narrow bandgap, resulting in reduced power output per cell; (b) short carrier lifetimes that limit charge collection efficiency; (c) susceptibility to radiation-induced lattice damage that degrades device performance over time; and (d) high rates of electron-hole pair recombination that waste a significant fraction of the generated charge.

More recently, wide bandgap semiconductors including silicon carbide (SiC, bandgap 3.26 eV), gallium nitride (GaN, bandgap 3.4 eV), and diamond (bandgap 5.5 eV) have been investigated for nuclear voltaic applications. These materials offer inherently higher open-circuit voltages, improved radiation hardness, and longer carrier lifetimes compared to their narrow bandgap counterparts. Diamond-based nuclear voltaic devices, in particular, have demonstrated near-100% charge collection efficiency due to the wide bandgap making charge recombination more difficult, with carrier lifetimes approaching 2000 nanoseconds.

However, existing wide bandgap semiconductor nuclear voltaic devices are fabricated using single-crystal or bulk polycrystalline wafer technology. Single-crystal growth of wide bandgap materials is expensive, technically challenging, and limited in achievable wafer sizes. The epitaxial processes required for device fabrication, particularly for SiC, demand high temperatures that add complexity and cost. Furthermore, conventional planar device geometries waste substantial fractions of the emitted radiation because only particles traveling perpendicular to the semiconductor surface are efficiently captured, while obliquely incident particles may escape without full energy deposition.

Additionally, prior art nuclear voltaic devices do not exploit quantum mechanical phenomena that become significant at the nanoscale. When semiconductor structures are reduced to dimensions comparable to the de Broglie wavelength of charge carriers (typically less than approximately 10 nanometers), quantum effects including quantum confinement, the quantum-confined Stark effect, Lamb shift, Casimir effect, and Purcell effect can fundamentally alter the electronic band structure, carrier dynamics, and photon emission properties. These effects, well-understood in quantum dot photovoltaics and quantum optoelectronics, have not been systematically applied to nuclear voltaic energy conversion.

There exists, therefore, a need for a nuclear voltaic converter that: (a) utilizes microcrystalline wide bandgap semiconductor materials with engineered grain sizes to exploit quantum mechanical effects; (b) achieves enhanced charge generation, separation, and collection efficiency through quantum confinement and related phenomena; (c) provides both planar and spherical device geometries for application flexibility; (d) demonstrates robust radiation tolerance through the inherent self-healing properties of microcrystalline grain boundaries; and (e) is scalable and adaptable for diverse applications ranging from milliwatt-scale sensor power to multi-watt remote power systems.

### SUMMARY OF THE INVENTION

The present invention provides a high-efficiency solid-state converter for nuclear voltaic power systems that overcomes the limitations of the prior art. The converter employs advanced microcrystalline wide bandgap semiconductor materials that are specifically engineered to exploit quantum mechanical phenomena to optimize charge generation, separation, and collection from radioisotope radiation.

In accordance with one aspect of the invention, a nuclear voltaic power source is provided comprising: at least one radioisotope configured to emit ionizing radiation; a microcrystalline wide bandgap semiconductor converter comprising at least one p-n junction formed from microcrystalline grains having dimensions selected to produce quantum confinement effects; at least one electrical contact system for extracting generated electrical charge; and a containment structure encompassing the radioisotope and the converter. The microcrystalline semiconductor is selected from the group consisting of diamond, silicon carbide (SiC), gallium nitride (GaN), gallium oxide (Ga2O3), boron nitride (BN), aluminum nitride (AlN), zinc oxide (ZnO), and combinations thereof.

In accordance with another aspect of the invention, a layered planar nuclear voltaic converter is provided comprising alternating layers of radioisotope material and microcrystalline wide bandgap semiconductor material, wherein each semiconductor layer comprises a p-n junction formed by appropriately doped microcrystalline grains. The planar configuration enables efficient fabrication using established thin-film deposition techniques while maintaining the quantum enhancement properties of the microcrystalline structure.

In accordance with yet another aspect of the invention, a spherical nuclear voltaic converter is provided comprising concentric spherical shells of microcrystalline wide bandgap semiconductor material interspersed with radioisotope material, wherein the spherical geometry provides isotropic radiation capture and the concentric shell structure acts as an optical resonant cavity that enhances the Purcell effect for improved energy conversion.

In accordance with a further aspect of the invention, a method of converting nuclear radiation energy to electrical energy is provided, comprising: providing at least one radioisotope source; positioning a microcrystalline wide bandgap semiconductor converter in radiation-receiving relationship with the radioisotope source, wherein the converter has grain dimensions selected to produce at least one quantum mechanical effect selected from the group consisting of quantum confinement effect, quantum-confined Stark effect, Lamb shift, Casimir effect, and Purcell effect; generating electron-hole pairs within the converter through interaction with the ionizing radiation; and collecting the generated charge carriers through electrical contacts to produce electrical current.

The invention achieves significant advantages over the prior art including: enhanced energy conversion efficiency through quantum-mechanical optimization of carrier generation and separation; robust radiation tolerance through microcrystalline grain boundary self-healing; design flexibility through both planar and spherical configurations; scalability from microwatt to multi-watt power levels; and long operational lifetime commensurate with the half-life of the selected radioisotope.

### BRIEF DESCRIPTION OF THE DRAWINGS

The present invention will be more fully understood from the following detailed description taken in conjunction with the accompanying drawings, in which:

FIG. 1 is a cross-sectional side view of a layered planar microcrystalline converter in accordance with a first embodiment of the invention, showing the alternating layers of radioisotope material and microcrystalline semiconductor material with p-n junctions and electrical contacts.

FIG. 2 is a cross-sectional view of a spherical microcrystalline converter in accordance with a second embodiment of the invention, showing concentric spherical shells of semiconductor material with radioisotope material disposed therebetween.

FIG. 3 is an enlarged detail view of a microcrystalline semiconductor layer showing the grain structure, p-n junction formation, and quantum confinement regions at grain boundaries.

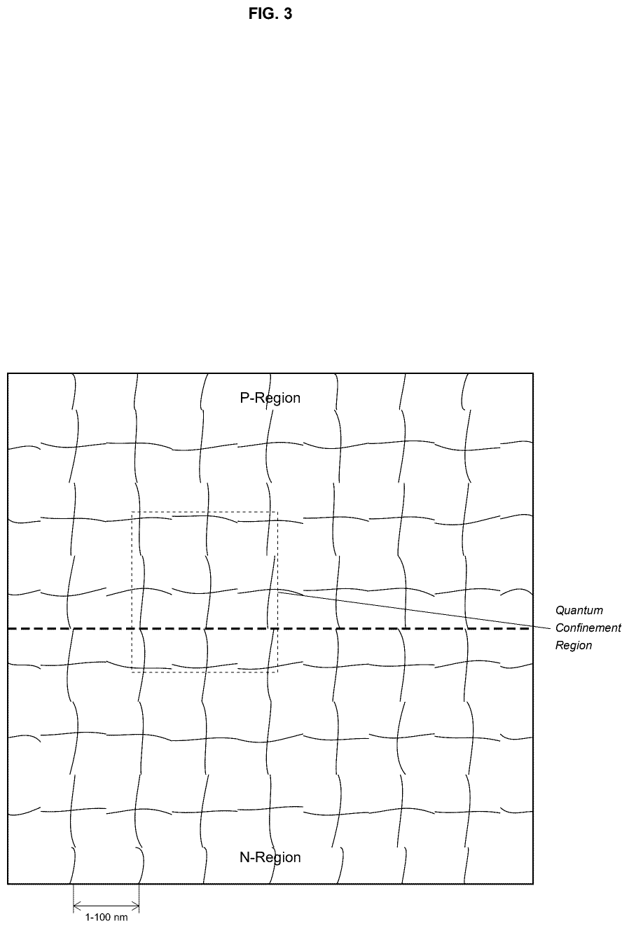

FIG. 4 is a schematic energy band diagram illustrating the quantum confinement effect, quantum-confined Stark effect, and Lamb shift within a microcrystalline grain of the converter.

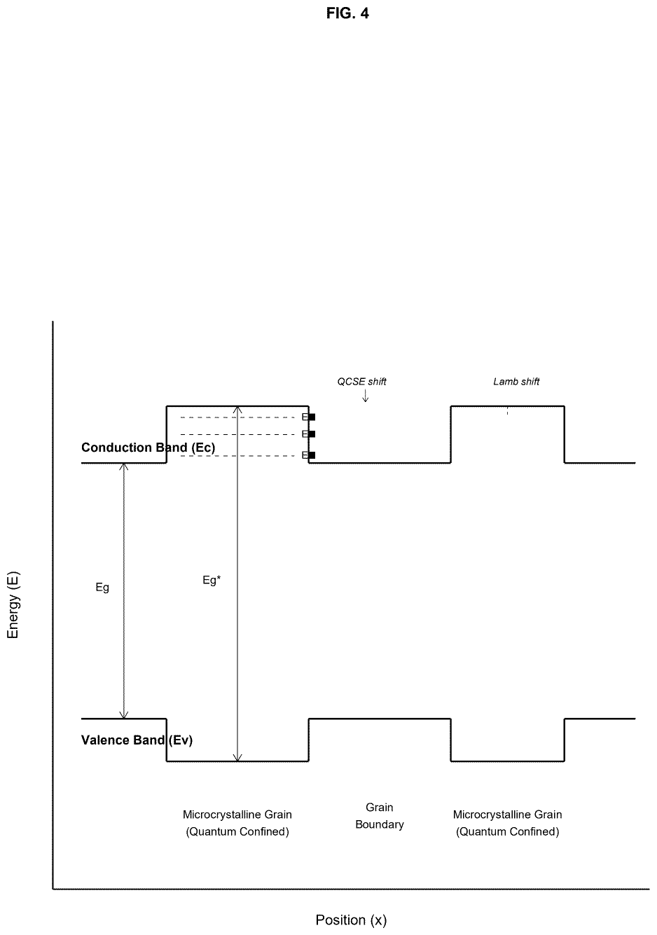

FIG. 5 is an exploded assembly view of a complete nuclear voltaic power cell incorporating the layered planar converter of FIG. 1, showing the containment structure, radiation shielding, and external electrical terminals.

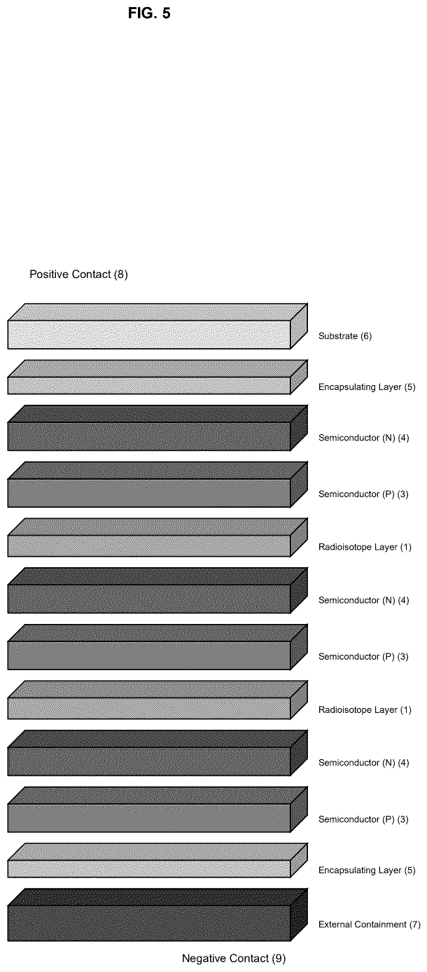

FIG. 6 is an exploded assembly view of a complete nuclear voltaic power cell incorporating the spherical converter of FIG. 2, showing the containment structure and electrical contact cylinders.

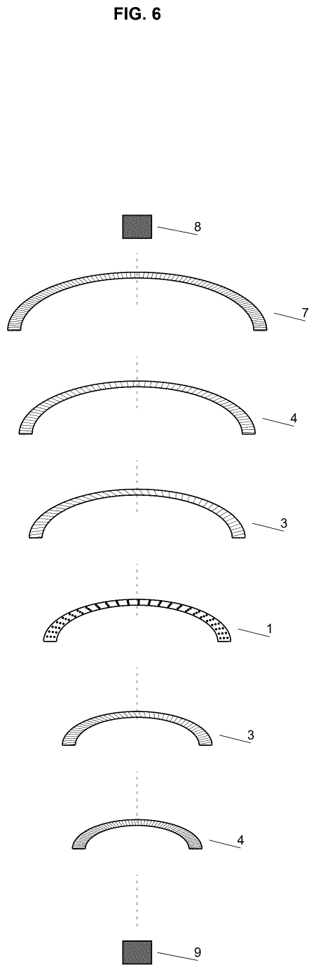

FIG. 7 is a parts identification diagram identifying the numbered components referenced throughout the specification.

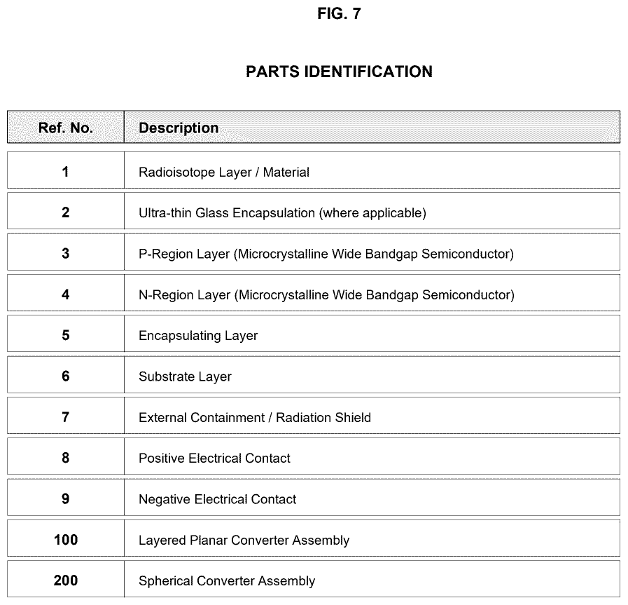

FIG. 8 is a diagram illustrating the Casimir effect between adjacent microcrystalline semiconductor layers and the resulting enhancement of the Lamb shift.

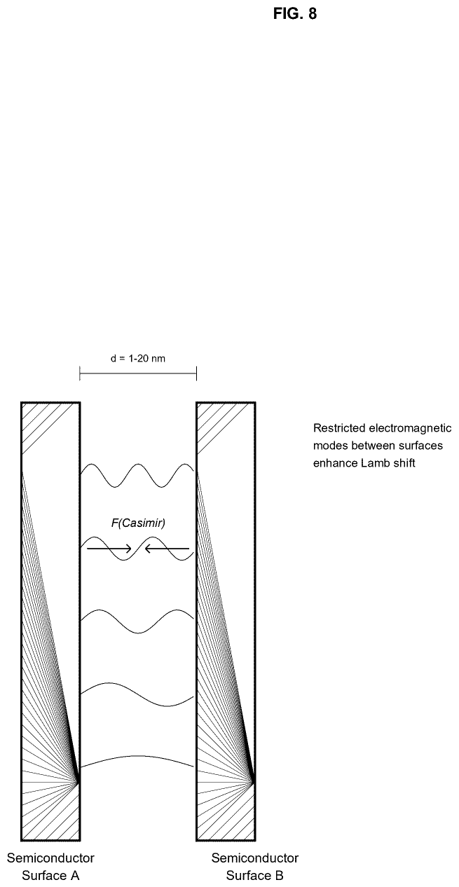

FIG. 9 is a diagram illustrating the Purcell effect enhancement in the spherical resonant cavity configuration.

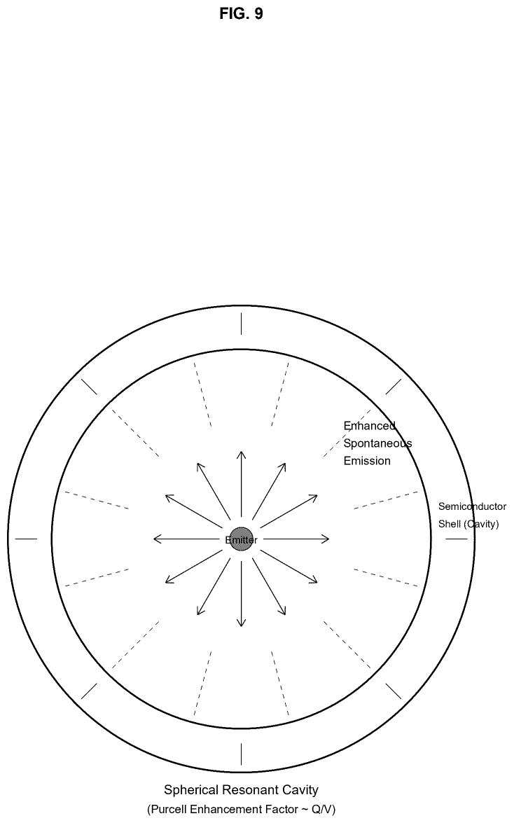

FIG. 10 is a schematic diagram showing a series-parallel electrical connection arrangement of multiple converter cells for voltage and current scaling.

### DETAILED DESCRIPTION OF PREFERRED EMBODIMENTS

### I. Overview of the Invention

The present invention provides a nuclear voltaic converter that fundamentally differs from prior art devices by employing microcrystalline wide bandgap semiconductor materials with grain dimensions specifically engineered to produce quantum mechanical effects that enhance energy conversion efficiency. Unlike conventional nuclear voltaic devices that use single-crystal or bulk polycrystalline semiconductor wafers, the present invention utilizes microcrystalline grains having average dimensions in the range of approximately 1 nanometer to approximately 100 nanometers, and more preferably in the range of approximately 2 nanometers to approximately 50 nanometers. At these dimensions, quantum confinement effects become significant and can be exploited to modify the electronic band structure of the semiconductor in ways that enhance charge carrier generation, separation, and collection.

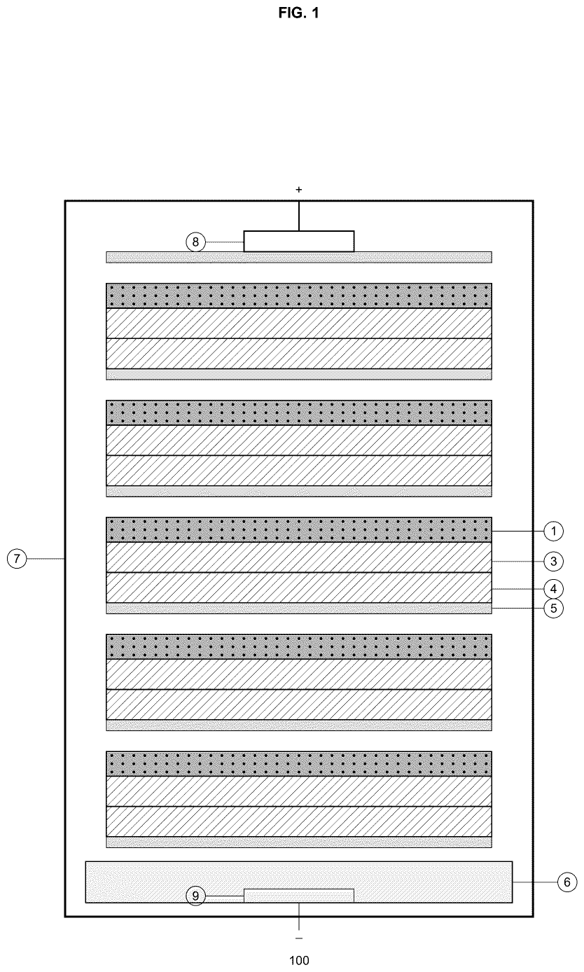

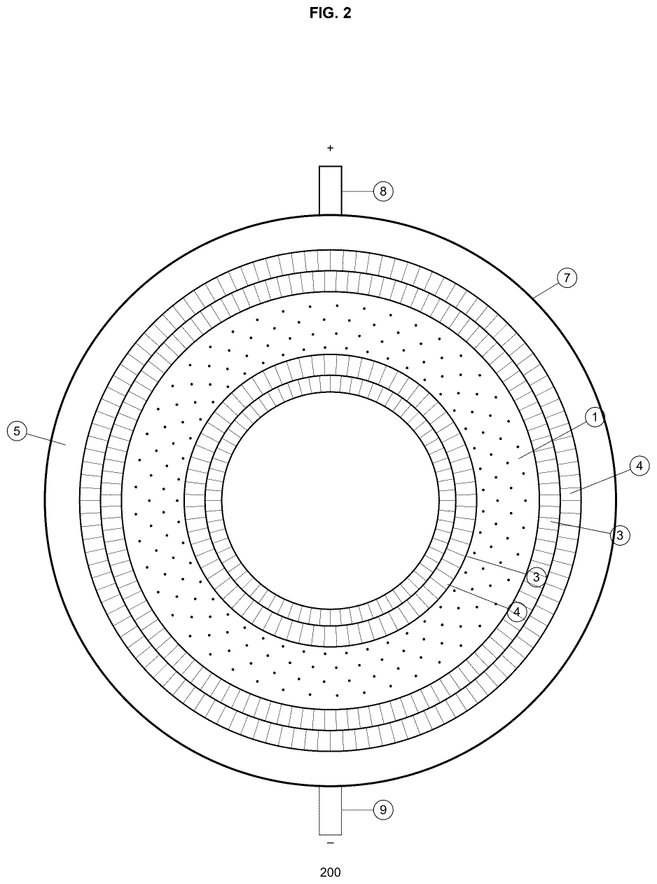

The converter is adaptable to two primary geometric configurations: (1) a layered planar structure, as shown in FIG. 1, wherein alternating planar layers of radioisotope material and microcrystalline semiconductor are stacked to form a multi-cell converter; and (2) a spherical structure, as shown in FIG. 2, wherein concentric spherical shells of microcrystalline semiconductor are interspersed with radioisotope material to form a three-dimensional converter with isotropic radiation capture. Both configurations exploit the same quantum mechanical phenomena but offer different advantages depending on the intended application.

### II. Radioisotope Sources

The converter of the present invention is designed to operate with a wide variety of radioisotope sources. The selection of radioisotope is determined by the intended application, required power output, desired operational lifetime, radiation type (alpha, beta, or gamma), and regulatory considerations. In preferred embodiments, the radioisotope is selected from the group consisting of: Phosphorus-32 (P-32), Vanadium-48 (V-48), Californium-253 (Cf-253), Chromium-51 (Cr-51), Mendelevium-258 (Md-258), Beryllium-7 (Be-7), Californium-254 (Cf-254), Cobalt-56 (Co-56), Scandium-46 (Sc-46), Sulfur-35 (S-35), Thulium-168 (Tm-168), Fermium-257 (Fm-257), Thulium-170 (Tm-170), Polonium-210 (Po-210), Calcium-45 (Ca-45), Gold-195 (Au-195), Zinc-65 (Zn-65), Cobalt-57 (Co-57), Vanadium-49 (V-49), Californium-248 (Cf-248), Ruthenium-106 (Ru-106), Neptunium-235 (Np-235), Cadmium-109 (Cd-109), Thulium-171 (Tm-171), Cesium-134 (Cs-134), Sodium-22 (Na-22), Iron-55 (Fe-55), Rhodium-101 (Rh-101), Cobalt-60 (Co-60), Krypton-85 (Kr-85), Tritium (H-3), Californium-250 (Cf-250), Niobium-93m (Nb-93m), Strontium-90 (Sr-90), Curium-243 (Cm-243), Cesium-137 (Cs-137), Titanium-44 (Ti-44), Uranium-232 (U-232), Plutonium-238 (Pu-238), Samarium-151 (Sm-151), Nickel-63 (Ni-63), Silicon-32 (Si-32), Argon-39 (Ar-39), Californium-249 (Cf-249), Silver-108m (Ag-108m), Americium-241 (Am-241), Mercury-194 (Hg-194), Niobium-91 (Nb-91), Californium-251 (Cf-251), Holmium-166m1 (Ho-166m1), Berkelium-247 (Bk-247), Radium-226 (Ra-226), Molybdenum-93 (Mo-93), Carbon-14 (C-14), Curium-244 (Cm-244), Curium-245 (Cm-245), Curium-246 (Cm-246), and combinations thereof.

In a particularly preferred embodiment for long-lifetime, moderate-power applications, the radioisotope comprises Nickel-63 (Ni-63), which has a half-life of approximately 100.1 years and emits beta particles with a maximum energy of 66.95 keV. In another preferred embodiment for higher-power applications, the radioisotope comprises Strontium-90(Sr-90 ), which has a half-life of approximately 28.8 years and emits beta particles with significantly higher energy. In yet another preferred embodiment, the radioisotope comprises Tritium (H-3), which has a half-life of approximately 12.3 years and emits low-energy beta particles (maximum 18.6 keV) particularly suitable for use with wide bandgap semiconductors where the beta energy is below the radiation damage threshold. In a further preferred embodiment for high-power-density applications, the radioisotope comprises Americium-241 (Am-241) or Plutonium-238 (Pu-238), which emit alpha particles with energies on the order of 5-6 MeV.

The radioisotope may be provided in solid form, including but not limited to thin films, foils, electroplated layers, vapor-deposited coatings, powder compacts, and sintered ceramic forms. In preferred embodiments for the layered planar configuration, the radioisotope is provided as a thin-film layer having a thickness optimized to minimize self-absorption losses while maximizing the radiation flux entering the semiconductor converter. For beta-emitting radioisotopes, the optimal thickness is typically in the range of approximately 0.1 micrometers to approximately 10 micrometers, depending on the specific isotope and its beta energy spectrum. For alpha-emitting radioisotopes, the optimal thickness is typically in the range of approximately 0.5 micrometers to approximately 50 micrometers.

### III. Microcrystalline Wide Bandgap Semiconductor Converter

The central innovation of the present invention is the microcrystalline wide bandgap semiconductor converter. Unlike prior art nuclear voltaic devices that employ single-crystal or conventional polycrystalline semiconductors, the converter of the present invention utilizes microcrystalline semiconductor material comprising a plurality of crystalline grains having controlled dimensions in the nanometer to sub-micrometer range, specifically engineered to produce quantum mechanical effects that enhance energy conversion.

The microcrystalline semiconductor material is selected from the group consisting of: Silicon Carbide (SiC) having a bandgap of approximately 3.26 eV; Zinc Oxide (ZnO) having a bandgap of approximately 3.37 eV; Gallium Nitride (GaN) having a bandgap of approximately 3.4 eV; Gallium Oxide (Ga2O3) having a bandgap of approximately 4.8 eV; Diamond having a bandgap of approximately 5.5 eV; Boron Nitride (BN) having a bandgap of approximately 5.8 eV; Aluminum Nitride (AlN) having a bandgap of approximately 6.2 eV; and combinations, alloys, and heterostructures thereof.

In a preferred embodiment, the microcrystalline semiconductor is diamond, which offers the widest bandgap (5.5 eV), the highest charge collection efficiency (approaching 100%), the longest carrier lifetime (approximately 2000 ns), and the most robust radiation tolerance among the candidate materials. In another preferred embodiment, the microcrystalline semiconductor is 4H-SiC, which offers a mature fabrication technology base, good radiation hardness, and well-understood doping processes. In yet another preferred embodiment, the microcrystalline semiconductor is GaN, which offers a direct bandgap suitable for both charge carrier generation and potential photon emission applications.

### III.A. Grain Size Engineering for Quantum Effects

The microcrystalline grains of the semiconductor converter are engineered with controlled average dimensions to exploit specific quantum mechanical effects. The grain size is a critical design parameter that determines which quantum effects are active and their relative magnitudes. In general, quantum confinement effects become significant when at least one dimension of the crystalline grain is comparable to or smaller than the exciton Bohr radius of the semiconductor material. For diamond, the exciton Bohr radius is approximately 1.57 nm; for SiC, approximately 2.7 nm; for GaN, approximately 3.4 nm; for AlN, approximately 1.5 nm; and for ZnO, approximately 1.8 nm.

In a preferred embodiment for strong quantum confinement, the microcrystalline grains have average dimensions in the range of approximately 1 nm to approximately 10 nm, which is comparable to or less than twice the exciton Bohr radius. In this regime, the quantum confinement effect produces a significant increase in the effective bandgap of the semiconductor, which in turn increases the open-circuit voltage and reduces thermalization losses. The quantum-confined Stark effect is also strongly active in this regime, enabling electric-field-dependent tuning of the energy levels.

In another preferred embodiment for moderate quantum confinement, the microcrystalline grains have average dimensions in the range of approximately 10 nm to approximately 50 nm. In this regime, quantum confinement effects are present but less dominant, and the Lamb shift and Casimir effect become increasingly significant at the interfaces between adjacent grains. This regime offers a balance between quantum enhancement and practical fabrication considerations.

In yet another preferred embodiment for weak quantum confinement with dominant interface effects, the microcrystalline grains have average dimensions in the range of approximately 50 nm to approximately 100 nm. In this regime, the primary quantum effects arise from the engineered interfaces and grain boundaries rather than bulk confinement within individual grains. The Purcell effect, which depends on the resonant cavity properties of the overall structure rather than individual grain dimensions, remains fully active in this regime.

### III.B. Quantum Mechanical Effects

The microcrystalline converter of the present invention is designed to exploit five specific quantum mechanical phenomena, individually and in combination, to enhance nuclear voltaic energy conversion. Each effect contributes to one or more aspects of the energy conversion process, including charge carrier generation, separation, transport, and collection.

### III.B.1. Quantum Confinement Effect (QCE)

When charge carriers (electrons and holes) are confined within nanometric dimensions comparable to or smaller than the de Broglie wavelength, the continuous energy bands of the bulk semiconductor are replaced by discrete energy levels. This quantum confinement effect (QCE) produces an increase in the effective bandgap of the material, which is inversely proportional to the square of the confinement dimension. In the microcrystalline converter of the present invention, the quantum dots formed by the microcrystalline grains confine carriers in three dimensions, producing the strongest confinement effects. The increased bandgap results in: (a) higher open-circuit voltage per cell, enabling greater power extraction per unit of radiation energy absorbed; (b) modified density of states that can enhance the rate of electron-hole pair generation; and (c) reduced thermalization losses because the widened bandgap more closely matches the energy spectrum of the incident radiation.

### III.B.2. Quantum-Confined Stark Effect (QCSE)

The quantum-confined Stark effect (QCSE) describes the shift of energy levels and modification of optical properties that occurs when an electric field is applied to a quantum-confined structure. In the microcrystalline converter, the built-in electric field of the p-n junction, augmented by the local electric fields generated by the interaction of ionizing radiation with the semiconductor lattice, produces a QCSE that: (a) shifts the absorption edge, modifying the range of radiation energies that can efficiently generate electron-hole pairs; (b) increases the exciton lifetime by spatially separating the electron and hole wavefunctions within each quantum-confined grain, thereby reducing recombination rates; and (c) enables electric-field-dependent tuning of the energy conversion process. The QCSE is optimized by careful selection of the grain size and doping profile to match the expected radiation-induced electric fields.

### III.B.3. Lamb Shift

The Lamb shift is a quantum electrodynamic phenomenon arising from the interaction of charge carriers with vacuum fluctuations of the electromagnetic field. In small semiconductor quantum dots, the Lamb shift produces measurable shifts in energy levels that can be tuned by controlling the dot size and the local electromagnetic environment. In the microcrystalline converter of the present invention, the Lamb shift is utilized to: (a) fine-tune the energy levels within each microcrystalline grain for optimal matching with the radiation energy spectrum; (b) reduce the probability of non-radiative recombination by shifting energy levels away from defect-mediated recombination pathways; and (c) enhance the separation between electron and hole energy levels, improving the efficiency of charge extraction.

### III.B.4. Casimir Effect

The Casimir effect arises from quantum vacuum fluctuations between closely spaced surfaces. When two conducting or dielectric surfaces are separated by nanometric distances, the restriction of allowed electromagnetic modes between the surfaces produces a measurable force and modifies the local electromagnetic field environment. In the microcrystalline converter of the present invention, the Casimir effect is exploited through engineering the spacing between adjacent microcrystalline grains and between semiconductor layers. Specifically, the inter-grain spacing is controlled during fabrication to be in the range of approximately 1 nm to approximately 20 nm, which is the regime where Casimir effects are significant for semiconductor materials. The Casimir effect: (a) modifies the local electromagnetic environment in a manner that enhances the Lamb shift; (b) creates an additional built-in force that can aid charge carrier transport across grain boundaries; and (c) modifies the local density of electromagnetic states in ways that can enhance or suppress specific recombination pathways.

### III.B.5. Purcell Effect

The Purcell effect describes the enhancement of the spontaneous emission rate of a quantum system when it is placed inside a resonant cavity. The enhancement factor, known as the Purcell factor, is proportional to the quality factor of the cavity divided by its mode volume. In the microcrystalline converter of the present invention, the Purcell effect is particularly significant in the spherical configuration (FIG. 2), where the concentric spherical shells of semiconductor material form a natural resonant cavity. The spherical geometry provides: (a) enhanced spontaneous emission rates for radiative processes, improving the efficiency of energy conversion pathways that involve photon intermediaries; (b) directional enhancement of photon emission toward the photovoltaic conversion surfaces; and (c) suppression of emission into non-productive modes, reducing energy waste. In the planar configuration (FIG. 1), the Purcell effect is realized through the periodic layered structure, which forms a one-dimensional photonic crystal with resonant cavity properties.

### IV. Layered Planar Configuration (First Embodiment)

Referring now to FIG. 1, a layered planar microcrystalline converter in accordance with a first embodiment of the invention comprises a plurality of alternating layers arranged in a stacked configuration. The converter comprises: at least one radioisotope layer comprising a thin film of radioisotope material; at least one microcrystalline semiconductor layer comprising a P-region layer doped with acceptor atoms and an N-region layer doped with donor atoms, forming a p-n junction; at least one pair of electrical contacts comprising an ohmic contact and/or a Schottky contact for charge extraction; an encapsulating layer providing structural integrity and radiation containment; a substrate layer providing mechanical support; and an external containment structure enclosing the entire assembly.

In the layered planar configuration, the radioisotope layer is disposed between adjacent semiconductor layers, such that radiation emitted in both directions from the radioisotope layer is captured by the semiconductor. Each semiconductor layer comprises a microcrystalline wide bandgap semiconductor material with grains having dimensions in the range of approximately 1 nm to approximately 100 nm, formed into a p-n junction through appropriate doping of the P-region layer and N-region layer.

The P-region layer is doped with acceptor atoms appropriate for the selected semiconductor material. For diamond, the acceptor dopant is preferably boron (B). For SiC, the acceptor dopant is preferably aluminum (Al) or boron (B). For GaN, the acceptor dopant is preferably magnesium (Mg). For AlN, the acceptor dopant is preferably magnesium (Mg) or beryllium (Be). The doping concentration in the P-region is preferably in the range of approximately 1×10\hat{ }16 cm\hat{ }-3 to approximately 1×10\hat{ }19 cm\hat{ }-3, and more preferably in the range of approximately 1×10\hat{ }17 cm\hat{ }-3 to approximately 5×10\hat{ }cm\hat{ }-3.

The N-region layer is doped with donor atoms appropriate for the selected semiconductor material. For diamond, the donor dopant is preferably nitrogen (N) or phosphorus (P). For SiC, the donor dopant is preferably nitrogen (N) or phosphorus (P). For GaN, the donor dopant is preferably silicon (Si) or germanium (Ge). For AlN, the donor dopant is preferably silicon (Si). The doping concentration in the N-region is preferably in the range of approximately 1×10\hat{ }14 cm\hat{ }-3 to approximately 1×10\hat{ }18 cm\hat{ }-3, and more preferably in the range of approximately 1×10\hat{ }15 cm\hat{ }-3 to approximately 1×10\hat{ }17 cm\hat{ }-3.

The thickness of each semiconductor layer (comprising both the P-region and N-region) is preferably in the range of approximately 0.5 micrometers to approximately 20 micrometers, and more preferably in the range of approximately 1 micrometer to approximately 10 micrometers. The optimal thickness is determined by the energy and range of the radiation emitted by the selected radioisotope, with the semiconductor thickness preferably being at least equal to the penetration depth of the radiation in the semiconductor material, but not so thick as to introduce unnecessary series resistance.

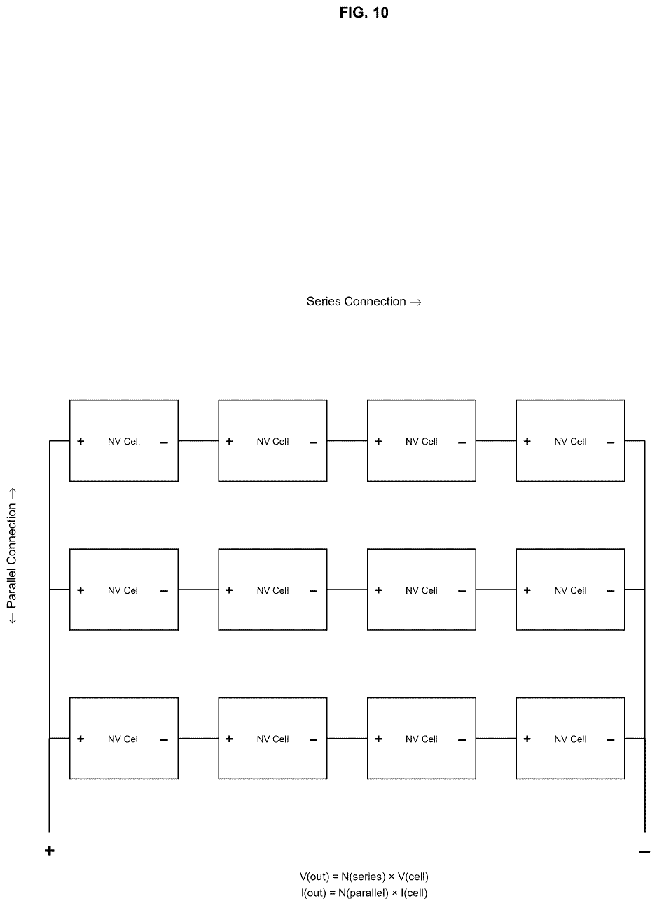

Multiple alternating layers of radioisotope and semiconductor may be stacked to increase the total active volume and power output. In a preferred embodiment, the converter comprises between 2 and 100 semiconductor layers, and more preferably between 5 and 50 semiconductor layers, each separated by a radioisotope layer. The individual layers may be connected electrically in series, in parallel, or in a combination of series and parallel connections to achieve the desired output voltage and current, as shown in FIG. 10.

### V. Spherical Configuration (Second Embodiment)

Referring now to FIG. 2, a spherical microcrystalline converter in accordance with a second embodiment of the invention comprises concentric spherical shells of microcrystalline semiconductor material interspersed with radioisotope material. The spherical converter comprises: an inner semiconductor sphere comprising P-region layer and N-region layer forming a p-n junction; an outer semiconductor sphere similarly comprising P-region and N-region layers; a gap between the inner and outer spheres filled with radioisotope material, which may be in solid, liquid, gaseous, or aerosolized form; electrical contacts connected to the P-region and N-region respectively via cylindrical contact elements; and a containment structure enclosing the assembly.

The spherical geometry provides several advantages over the planar configuration. First, the spherical geometry provides isotropic radiation capture; radiation emitted in any direction from the radioisotope material encounters a semiconductor surface at near-normal incidence, maximizing the probability of full energy deposition. Second, the concentric spherical shell structure forms a natural resonant cavity that enhances the Purcell effect. Third, the spherical geometry minimizes the surface-to-volume ratio, reducing surface recombination losses. Fourth, the spherical geometry is inherently suited to the stacking and assembly approach wherein spherical cells are sliced into disk segments and assembled into cylindrical battery form factors.

In a particularly preferred embodiment, the multi-layered spherical configuration comprises between 3 and 20 concentric spherical shells of microcrystalline semiconductor, each separated by a layer of radioisotope material. The spacing between adjacent semiconductor shells is preferably in the range of approximately 0.1 micrometers to approximately 100 micrometers, and more preferably in the range of approximately 1 micrometer to approximately 50 micrometers. This spacing is optimized to exploit the Casimir effect between adjacent semiconductor surfaces while providing sufficient volume for the radioisotope material to maximize the radiation flux.

### VI. Electrical Contacts

The converter of the present invention employs at least one electrical contact system for collecting and extracting the electrical charges generated within the semiconductor material. The electrical contact system may comprise Schottky contacts, ohmic contacts, or combinations thereof, depending on the specific semiconductor material and intended operating conditions.

### VI.A. Schottky Contacts

Schottky contacts form a metal-semiconductor junction characterized by a potential barrier (Schottky barrier) that enables rectifying behavior with low forward voltage drop and fast switching characteristics. The Schottky contact metal is selected based on its work function relative to the electron affinity of the semiconductor, which determines the barrier height and efficiency of the junction. Suitable Schottky contact metals include, but are not limited to: Aluminum (Al, work function approximately 4.28 eV); Titanium (Ti, work function approximately 4.33 eV); Gold (Au, work function approximately 5.1 eV); Nickel (Ni, work function approximately 5.15 eV); Palladium (Pd, work function approximately 5.6 eV); and Platinum (Pt, work function approximately 5.65 eV).

### VI.B. Ohmic Contacts

Ohmic contacts provide a linear current-voltage characteristic with minimal resistance at the metal-semiconductor interface, enabling efficient charge carrier extraction. The contact metal is selected to form a low-resistance interface with the specific semiconductor material. Suitable ohmic contact metals include, but are not limited to: Gold (Au, specific contact resistance approximately 10\hat{ }-6 to 10\hat{ }-5 ohm-cm\hat{ }2); Silver (Ag, specific contact resistance approximately 10\hat{ }-7 to 10\hat{ }-6 ohm-cm\hat{ }2); Aluminum (Al, specific contact resistance approximately 10\hat{ }-6 to 10\hat{ }-5 ohm-cm\hat{ }2); Titanium (Ti, specific contact resistance approximately 10\hat{ }-5 to 10\hat{ }-4 ohm-cm\hat{ }2); Nickel (Ni, specific contact resistance approximately 10\hat{ }-5 to 10\hat{ }-4 ohm-cm\hat{ }2); and Copper (Cu, specific contact resistance approximately 10\hat{ }-6 to 10\hat{ }-5 ohm-cm\hat{ }2).

In certain embodiments, specialized electrical contact materials may be employed for particular applications, including but not limited to: Indium Tin Oxide (ITO) for transparent contact applications; Graphene for ultra-low-resistance and flexible contact applications; Molybdenum (Mo) for high-temperature stability; Tungsten (W) for high-temperature and radiation-hard applications; and Chromium (Cr) for adhesion layer applications.

### VII. Containment and Shielding

The converter assembly is enclosed within a containment structure that provides: radiation shielding to prevent external exposure; mechanical protection; thermal management; and hermetic sealing to prevent release of radioisotope material. The containment structure may comprise one or more layers of shielding material selected from the group consisting of, but not limited to: SIFSIX-3-Cu; Inconel 617; GH3535; Ni-MOF-74; MOF-505; Stainless Steel 304 (tensile strength 515-625 MPa, density 7.93 g/cm\hat{ }3); Stainless Steel 316 (tensile strength 579 MPa, density 8.0 g/cm\hat{ }3); and combinations thereof. The selection of containment material is determined by the type and energy of radiation, the required mechanical strength, and the operating environment.

### VIII. Fabrication Methods

The microcrystalline semiconductor layers of the converter may be fabricated using a variety of thin-film deposition techniques known in the art, including but not limited to: chemical vapor deposition (CVD), including hot-filament CVD and microwave plasma-enhanced CVD; physical vapor deposition (PVD), including sputtering and pulsed laser deposition; molecular beam epitaxy (MBE); atomic layer deposition (ALD); sol-gel processing; and hydrothermal synthesis. The grain size of the microcrystalline semiconductor is controlled through deposition parameters including substrate temperature, gas flow rates, plasma power, and post-deposition annealing conditions.

In a preferred fabrication method, the microcrystalline grains are produced by: (a) depositing the semiconductor material using CVD or PVD at a substrate temperature below the temperature required for epitaxial single-crystal growth, thereby producing a microcrystalline or nanocrystalline film; (b) controlling the deposition rate and substrate temperature to achieve the desired average grain size in the range of 1 nm to 100 nm; and (c) performing optional post-deposition annealing at controlled temperatures to optimize the grain size distribution and grain boundary properties.

For the layered planar configuration, the fabrication process comprises: (a) preparing a substrate; (b) depositing a first microcrystalline semiconductor layer with p-n junction; (c) depositing or applying a radioisotope layer; (d) repeating steps (b) and (c) for the desired number of layers; and (e) applying electrical contacts and encapsulation. For the spherical configuration, fabrication may employ: (a) forming a core sphere of semiconductor material; (b) coating with radioisotope material; (c) depositing additional semiconductor shells using conformal deposition techniques; and (d) repeating for the desired number of shells.

### IX. Applications

The nuclear voltaic converter of the present invention is suitable for a wide range of applications requiring long-lived, maintenance-free electrical power sources, including but not limited to: space exploration power systems for spacecraft, satellites, and planetary rovers; remote terrestrial power systems for sensors, monitoring equipment, and communications relays in inaccessible locations; medical device power systems for implantable devices such as cardiac pacemakers, neurostimulators, and drug delivery pumps; military and defense applications including unattended ground sensors, remote surveillance equipment, and secure communications devices; deep-sea exploration power systems for autonomous underwater vehicles, ocean-floor sensors, and submarine equipment; Internet of Things (IoT) devices requiring decade-scale operational lifetimes without battery replacement; and emergency and disaster response power systems for critical infrastructure monitoring.

What is claimed is:

1. A nuclear voltaic power source comprising:
(a) at least one radioisotope configured to emit ionizing radiation selected from the group consisting of alpha particles, beta particles, gamma rays, and combinations thereof;
(b) a microcrystalline wide bandgap semiconductor converter disposed in radiation-receiving relationship with the at least one radioisotope, the converter comprising at least one p-n junction formed from microcrystalline grains of a wide bandgap semiconductor material, the microcrystalline grains having average dimensions in the range of approximately 1 nanometer to approximately 100 nanometers, the wide bandgap semiconductor material having a bandgap of at least 3.0 electron volts;
(c) at least one electrical contact electrically coupled to the converter for extracting electrical charge generated by interaction of the ionizing radiation with the microcrystalline wide bandgap semiconductor; and
(d) a containment structure encompassing the at least one radioisotope and the converter.

2. The nuclear voltaic power source of claim 1, wherein the wide bandgap semiconductor material is selected from the group consisting of diamond, silicon carbide (SiC), gallium nitride (GaN), gallium oxide (Ga2O3), boron nitride (BN), aluminum nitride (AlN), zinc oxide (ZnO), and combinations thereof.

3. The nuclear voltaic power source of claim 1, wherein the microcrystalline grains have average dimensions in the range of approximately 1 nanometer to approximately 10 nanometers, such that quantum confinement effects produce an increase in the effective bandgap of the semiconductor material.

4. The nuclear voltaic power source of claim 1, wherein the microcrystalline grains have average dimensions selected to produce at least one quantum mechanical effect selected from the group consisting of quantum confinement effect, quantum-confined Stark effect (QCSE), Lamb shift, Casimir effect, and Purcell effect.

5. The nuclear voltaic power source of claim 1, wherein the converter comprises a layered planar structure having a plurality of alternating layers of radioisotope material and microcrystalline semiconductor material.

6. The nuclear voltaic power source of claim 5, wherein the layered planar structure comprises between 2 and 100 microcrystalline semiconductor layers, each separated by a radioisotope layer.

7. The nuclear voltaic power source of claim 1, wherein the at least one electrical contact comprises a Schottky contact formed from a metal selected from the group consisting of aluminum, titanium, gold, nickel, palladium, platinum, and combinations thereof.

8. The nuclear voltaic power source of claim 1, wherein the at least one electrical contact comprises an ohmic contact formed from a metal selected from the group consisting of gold, silver, aluminum, titanium, nickel, copper, and combinations thereof.

9. The nuclear voltaic power source of claim 1, wherein the radioisotope is selected from the group consisting of Tritium (H-3), Nickel-63, Carbon-14, Strontium-90, Cesium-137, Americium-241, Plutonium-238, Cobalt-60, Krypton-85, Iron-55, and combinations thereof.

10. The nuclear voltaic power source of claim 1, wherein the wide bandgap semiconductor material is diamond having a bandgap of approximately 5.5 eV, and the microcrystalline grains have average dimensions of approximately 2 nanometers to approximately 10 nanometers.

11. The nuclear voltaic power source of claim 1, wherein the containment structure comprises at least one radiation shielding material selected from the group consisting of SIFSIX-3-Cu, Inconel 617, GH3535, Ni-MOF-74, MOF-505, stainless steel, and combinations thereof.

12. The nuclear voltaic power source of claim 1, wherein the microcrystalline grains are formed by a deposition process selected from the group consisting of chemical vapor deposition, physical vapor deposition, molecular beam epitaxy, atomic layer deposition, sol-gel processing, and hydrothermal synthesis.

13. A spherical nuclear voltaic power source comprising:
(a) at least one radioisotope configured to emit ionizing radiation;
(b) a plurality of concentric spherical shells of microcrystalline wide bandgap semiconductor material, each shell comprising at least one p-n junction formed from microcrystalline grains having average dimensions in the range of approximately 1 nanometer to approximately 100 nanometers, the wide bandgap semiconductor material having a bandgap of at least 3.0 electron volts;
(c) radioisotope material disposed in the spaces between adjacent concentric spherical shells;
(d) at least one electrical contact electrically coupled to at least one of the concentric spherical shells for extracting electrical charge; and
(e) a containment structure encompassing the concentric spherical shells and the radioisotope material;
wherein the concentric spherical shells form a resonant cavity that enhances the Purcell effect for spontaneous emission within the converter.

14. The spherical nuclear voltaic power source of claim 13, comprising between 3 and 20 concentric spherical shells of microcrystalline semiconductor material.

15. The spherical nuclear voltaic power source of claim 13, wherein the spacing between adjacent concentric spherical shells is in the range of approximately 0.1 micrometers to approximately 100 micrometers.

16. The spherical nuclear voltaic power source of claim 13, wherein the spacing between adjacent concentric spherical shells is selected to exploit the Casimir effect between adjacent semiconductor surfaces.

17. The spherical nuclear voltaic power source of claim 13, wherein the radioisotope material disposed between the concentric spherical shells is in a form selected from the group consisting of solid thin films, powders, gaseous phase, aerosolized particles, and liquid phase.

18. The spherical nuclear voltaic power source of claim 13, further comprising a dual-sphere subconfiguration wherein a smaller inner sphere is enclosed by a larger outer sphere, with the radioisotope material filling the intervening space.

19. A method of converting nuclear radiation energy to electrical energy, the method comprising:
(a) providing at least one radioisotope source emitting ionizing radiation;
(b) positioning a microcrystalline wide bandgap semiconductor converter in radiation-receiving relationship with the radioisotope source, the converter comprising microcrystalline grains of a wide bandgap semiconductor material having average dimensions in the range of approximately 1 nanometer to approximately 100 nanometers and a bandgap of at least 3.0 electron volts, wherein the grain dimensions are selected to produce at least one quantum mechanical effect selected from the group consisting of quantum confinement effect, quantum-confined Stark effect, Lamb shift, Casimir effect, and Purcell effect;
(c) generating electron-hole pairs within the converter through interaction of the ionizing radiation with the microcrystalline semiconductor;
(d) separating the generated electron-hole pairs through a built-in electric field of at least one p-n junction within the converter; and
(e) collecting the separated charge carriers through at least one electrical contact to produce electrical current.

20. The method of claim 19, wherein the quantum mechanical effect comprises quantum confinement effect, and the grain dimensions are selected to be comparable to or smaller than twice the exciton Bohr radius of the wide bandgap semiconductor material.

21. The method of claim 19, wherein the converter is configured in a layered planar geometry comprising alternating layers of radioisotope material and microcrystalline semiconductor material.

22. The method of claim 19, wherein the converter is configured in a spherical geometry comprising concentric spherical shells of microcrystalline semiconductor material with radioisotope material disposed therebetween.

23. The method of claim 19, further comprising engineering the spacing between microcrystalline grains to be in the range of approximately 1 nanometer to approximately 20 nanometers to exploit the Casimir effect for enhanced Lamb shift.

24. The method of claim 19, further comprising forming the converter as a resonant cavity structure to enhance the Purcell effect for spontaneous emission.

25. The method of claim 19, wherein the wide bandgap semiconductor material is diamond and the radioisotope is selected from the group consisting of Tritium, Nickel-63, and Carbon-14.

26. A nuclear voltaic energy conversion system comprising:
(a) a plurality of nuclear voltaic power cells, each power cell comprising: (i) at least one radioisotope; (ii) a microcrystalline wide bandgap semiconductor converter having microcrystalline grains with average dimensions in the range of approximately 1 nanometer to approximately 100 nanometers, the converter comprising at least one p-n junction; and (iii) at least one electrical contact;
(b) an electrical interconnection system connecting the plurality of power cells in at least one configuration selected from the group consisting of series connection, parallel connection, and series-parallel combination; and
(c) a containment and shielding assembly enclosing the plurality of power cells.

27. The system of claim 26, wherein each power cell has a spherical geometry, and a plurality of spherical power cells are assembled into a cylindrical battery form factor.

28. The system of claim 26, wherein each power cell exploits at least two quantum mechanical effects selected from the group consisting of quantum confinement effect, quantum-confined Stark effect, Lamb shift, Casimir effect, and Purcell effect.

29. The system of claim 26, wherein the microcrystalline wide bandgap semiconductor converter comprises microcrystalline diamond grains having average dimensions in the range of approximately 2 nanometers to approximately 50 nanometers.

30. The system of claim 26, wherein the plurality of power cells comprises at least two power cells having different radioisotopes selected to provide a combined power output profile over a desired operational lifetime.
